(19) United States
(12) Patent Application Publication
(10) Pub. No.: US 2006/0041472 A1
(43) Pub. Date: Feb. 23, 2006

(54) Systems and methods of interfacing an advertisement with a message presentation client

(76) Inventors: Rajan M. Lukose, Palo Alto, CA (US); Joshua R. Tyler, Palo Alto, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/924,457

(22) Filed: Aug. 23, 2004

(51) Int. Cl. G06Q 30/00

(52) U.S. Cl. 705/14

(57) ABSTRACT

Systems and methods of advertising are presented herein. In some embodiments, a method may comprise collecting data on a consumer computer, receiving a signal having advertisement information and target criteria, and comparing said target criteria with the data. If the target criteria matches with the data, the method further comprises interfacing the advertisement information in a message format compatible with a message presentation client executed by the consumer computer.

### BACKGROUND

The Internet couples millions of computers together and provides computer users with a variety of capabilities. For example, using the Internet, computer users may view text and graphics, make purchases, send and receive electronic mail, and search for information. As a result, the Internet has become a valuable tool.

Due to the number of computer users that access the Internet, advertising on the Internet has developed into a significant market. Common types of Internet advertisement services include “spam” email (unsolicited commercial email), pop-up advertisement banners, and consumer profiling (i.e., tracking and selling consumer information including Internet activities).

Unfortunately, there are many shortcomings in these Internet advertisement services. For example, spam email and advertisement banners may not effectively target consumers and can be highly inefficient. Further, consumer profiling may encroach on consumer privacy.

In U.S. patent application Ser. No. 10/639,140, entitled “Targeted Advertisement with Local Consumer Profile” a system and method intended to resolve the above shortcomings were described. However, consumers may be accustomed to working within one, or a few programs, and may be reluctant to “try out” new software programs.

### BRIEF SUMMARY

Systems and methods of advertising are presented herein. In some embodiments, a method may comprise collecting data on a consumer computer, receiving a signal having advertisement information and target criteria, and comparing said target criteria with the data. If the target criteria matches with the data, the method further comprises interfacing the advertisement information in a message format compatible with a message presentation client executed by the consumer computer.

### BRIEF DESCRIPTION OF THE DRAWINGS

For a detailed description of the embodiments of the invention, reference will now be made to the accompanying drawings in which:

FIG. 1A shows a block diagram illustrating a system according to an embodiment of the invention;

FIG. 1B shows a block diagram illustrating a system according to an alternative embodiment of the invention;

FIG. 2A shows a computer system according to an embodiments of the invention;

FIG. 2B shown another computer system according to alternative embodiments of the invention;

FIG. 3 shows a block diagram illustrating a system according to another embodiment of the invention;

FIG. 4 shows a flowchart illustrating a method for advertising according to an embodiment of the invention; and

FIG. 5 shows a flowchart illustrating a method for advertising according to another embodiment of the invention.

### NOTATION AND NOMENCLATURE

Certain terms are used throughout the following description and claims to refer to particular system components. As one skilled in the art will appreciate, computer companies may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . . ” Also, the term “couple” or “couples” is intended to mean either an indirect or direct electrical connection. Thus, if a first device couples to a second device, that connection may be through a direct electrical connection, or through an indirect electrical connection via other devices and connections. The term “system” refers to a collection of two or more parts and may be used to refer to a computer system or a portion of a computer system.

### DETAILED DESCRIPTION

The following discussion is directed to various embodiments of the invention. Although one or more of these embodiments may be preferred, the embodiments disclosed should not be interpreted, or otherwise used, as limiting the scope of the disclosure, including the claims. In addition, one skilled in the art will understand that the following description has broad application, and the discussion of any embodiment is meant only to be exemplary of that embodiment, and not intended to intimate that the scope of the disclosure, including the claims, is limited to that embodiment.

There is presented herein various embodiments of an advertising technique that may be beneficial to, among other entities, advertisers and consumers. More specifically, the embodiments of the invention permit advertisers to find consumers that match a desired consumer profile, while permitting consumers to control their own personal information. The presentation of advertisements may be performed by a communication platform (i.e., a message presentation client) that permits consumers to receive visual and/or audible messages. The communication platform may comprise an email application, an instant messaging application, a voice over IP (Internet protocol) application, printer applications or another computer-based communication interface that permits consumers to receive new messages. By presenting advertisements via the communication platform, consumers are able to receive targeted advertisements as an extension to receiving other messages. The following describes embodiments of the invention in terms of consumers and advertisers merely by way of example, and is not limited to that context.

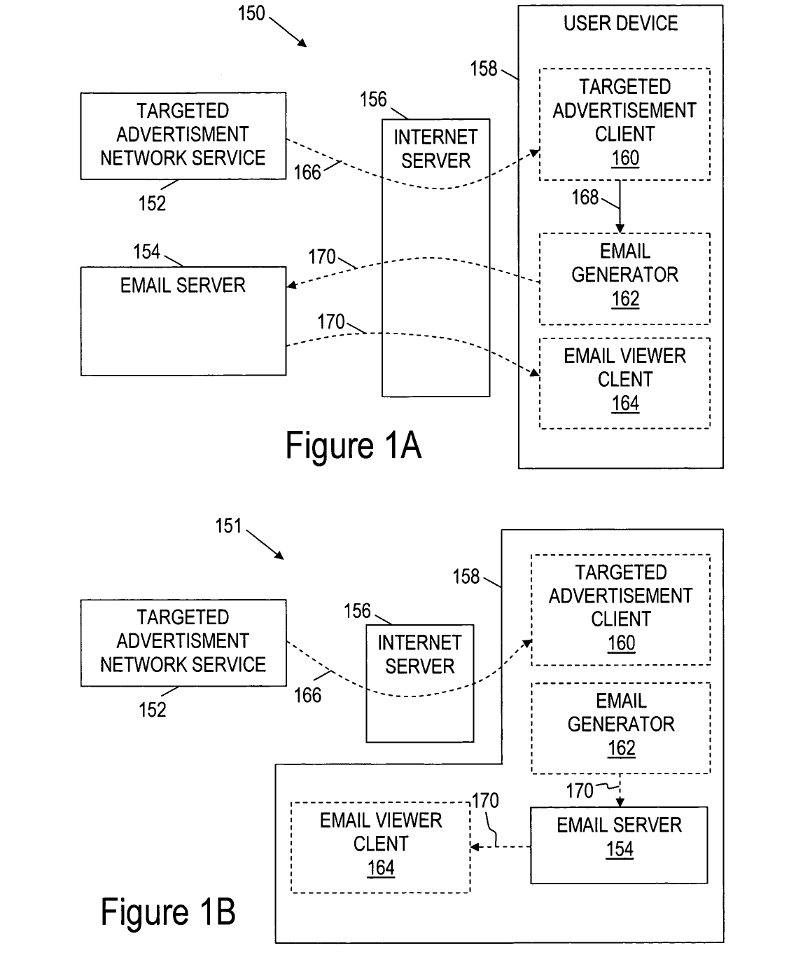

FIG. 1A shows a block diagram of a system 150 according to an embodiment of the invention. As shown in FIG. 1, the system 150 may comprise a targeted advertisement network service 152 that couples to a user device 158 via an Internet server 156 or other network server. The targeted advertisement network service 152 may broadcast a targeted advertisement 166 to a targeted advertisement client 160 stored locally and executed by the user device 158. The targeted advertisement 166 may be received by the user device 158 using a wired or a wireless method. The user device 158 may be a computer, a mobile phone, a personal digital assistant (PDA), or other Internet-enabled devices. In response to the targeted advertisement 166, the targeted advertisement client 160 may assert a signal 168 to an email generator 162 coupled to the targeted advertisement client 160. For example, the signal 168 may be asserted if target criteria of the targeted advertisement 166 matches a threshold amount of information and/or a bid price stored by the targeted advertisement client 160.

Upon receiving the asserted signal 168, the email generator 162 may generate an email 170 that is transmitted to an email server 154 via the Internet server 156. The email 170 may include information provided with the targeted advertisement 166 (e.g., an advertisement, an advertisement link, or other information associated with an advertisement). The email server 154 may forward the email 170 to an email viewer client 164 (e.g., an email browser) so that a user of the user computer 158 may view the advertisement associated with the email 170. The user also may view other emails.

Although the advertisement may be presented to the user via a communication medium such as the email 170, the targeted advertisement 166 may or may not be broadcast as email. In general, the targeted advertisement 166 may be any electronic signal that carries target criteria interpretable by the targeted advertisement client 160. The targeted advertisement 166 also may comprise image data, audio data, reward information or hyperlink information associated with an advertisement.

In some embodiments, the targeted advertisement network service 152 and the targeted advertisement client 160 may implement a protocol that permits transmission of targeted advertisements 166 to the targeted advertisement client 160 without revealing the location of the user device 158, user identification information or other sensitive information that a user of the user device 158 may not want to reveal to all advertisers. Upon receiving targeted advertisements 166, the targeted advertisement client 160 may compare the target criteria with user criteria logged and stored by the targeted advertisement client 160. If the target criteria and the user criteria match (i.e., if greater than a threshold amount of matching occurs), the targeted advertisement client 160 causes the email generator 162 to generate an email 170 and interface the image data, audio data, reward information or hyperlink information transmitted with the targeted advertisement 166 to the email 170.

FIG. 1B shows a block diagram of a system 151 according to an alternative embodiment of the invention. As shown in FIG. 1B, the email server 154 may be a local component of the user device 158. In such embodiments, the email 170 generated by the email generator 162 is transferred to the email server 154 and the email viewer client 164 locally (i.e., without accessing the Internet server 156). The embodiment of FIG. 1B may allow simplified and/or improved security compared to embodiments that transmit emails 170 to and from the Internet server 156.

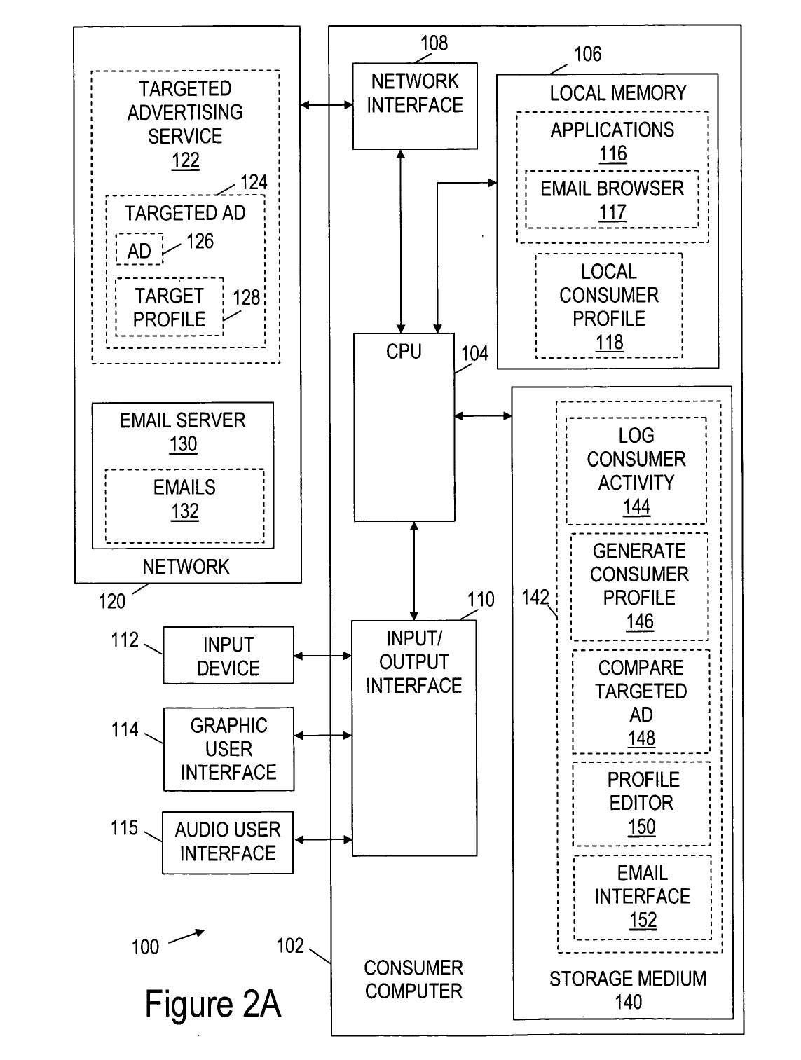

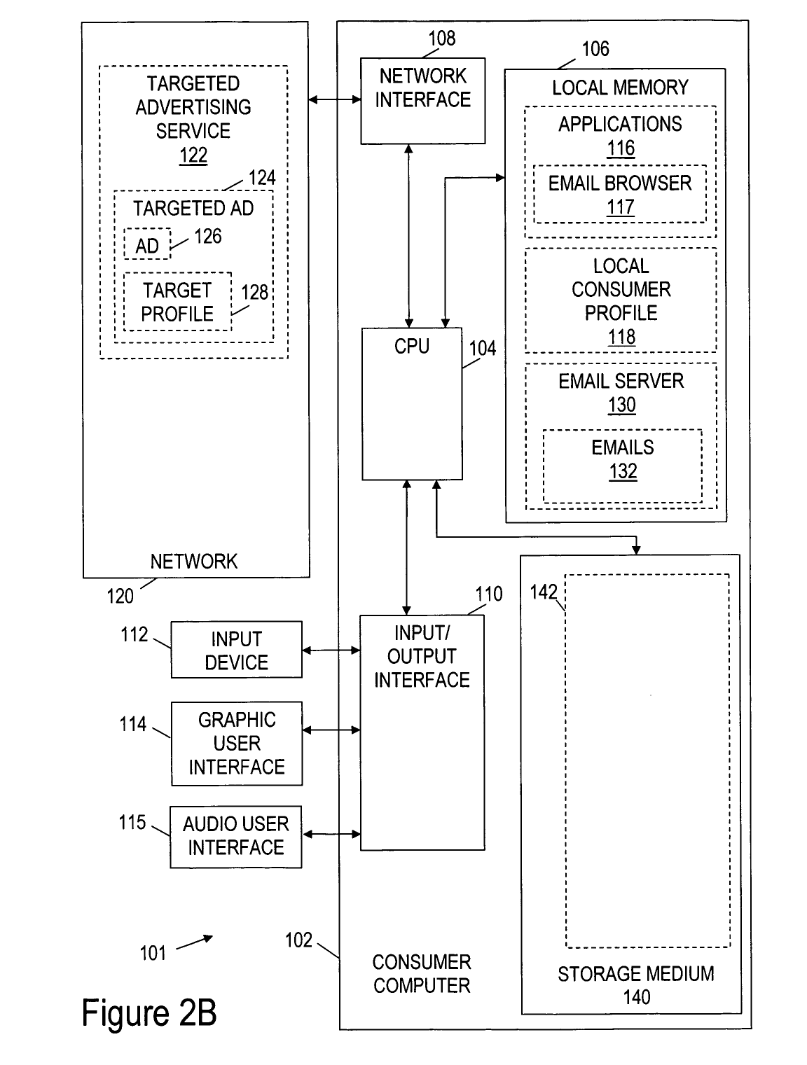

FIG. 2A shows a block diagram of a computer system 100 according to an embodiment of the invention. As shown in FIG. 2A, the system 100 may comprise a consumer computer 102 coupled to a network 120 that comprises a targeted advertising service 122 and an email server 130. As will be described herein, the system 100 provides an interface between advertisers and consumers such that advertisers are able to present advertisements to target consumers and consumers are able to control the use of their personal information and the reception of advertisements. Accordingly, the consumer computer 102 may couple to an input device 112, such as a keyboard and/or mouse, through which a consumer may control one or more activities of the consumer computer 102. The consumer computer 102 also may couple to a graphic user interface 114 (e.g., a cathode ray tube monitor, an LCD monitor, or a touch-screen monitor) that provides a visual interface to the consumer. The consumer computer 102 also may couple to an audio user interface 115 (e.g., a speaker or a microphone) that provides a sound-based interface to the consumer. Although FIGS. 2A and 2B illustrate embodiments in which advertisements are presented to a consumer via an email communication platform, other embodiments may present advertisements via some other communication platform such as instant messaging, voice over IP, printing offers directly to a consumer's printer, direct mail, or other communication platforms now known or later developed.

As shown in FIG. 2A, the consumer computer 102 may comprise a CPU (central processing unit) 104 coupled to a local memory 106, a network interface 108, an input/output interface 110, and an instruction storage medium 140. The instruction storage medium 140 may comprise any of a variety of media for storing computer-readable instructions 142. Examples of a suitable instruction storage medium 140 include, a floppy disk, a compact disk, a volatile memory, a non-volatile memory, a hard drive, or a combination thereof. In at least some embodiments, the local memory 106 and the instruction storage medium 140 may be the same. The local memory 106 may comprise software applications 116 executable by the CPU 104 and a local consumer profile 118 that comprises “consumer profile information” (e.g., name, contact information, hobbies, associations, profession, computer-based activities or other consumer behavior information).

In some embodiments, the local consumer profile 118 may be generated and maintained by executing (e.g., with the CPU 104) some or all of the computer-readable instructions 142 stored in the instruction storage medium 140. As shown, the computer-readable instructions 142 may comprise: log consumer activity instructions 144, generate consumer profile instructions 146, compare targeted ad instructions 148, profile editor instructions 150, and email interface instructions 152.

When executed by the CPU 104, the log consumer activity instructions 144 may cause the CPU 104 to target and recognize when certain computer-based activities occur. For example, the logging instructions 144 may cause the CPU 104 to sample data passing through the CPU 104 and/or the network interface 108 and identify the software applications 116 that are used, web pages that are accessed, online memberships, online application forms, online registrations, time spent browsing web pages, web searches that are performed, email usage (including but not limited to the text, graphic, and/or video content of all emails, the addresses of recipients to which the consumer has sent email, and the addresses of senders which have sent email to the consumer), music files (purchased, stored, or listened to), video files (purchased, stored or watched), data records saved, and other computer-based activities. Additionally, the logging instructions 144 may cause the CPU 104 to store, e.g., in the local memory 106, information that identifies the computer-based activities.

When executed by the CPU 104, the generate consumer profile instructions 146 may cause the CPU 104 to organize the consumer profile information. In some embodiments, the generate consumer profile instructions 146 may automatically extract the consumer profile information acquired as described above and organize the consumer profile information in a searchable format (e.g., a database or other data structure). Alternatively or additionally, the instructions 146 may provide an interface that stores consumer profile information provided by a consumer via the input device 112, the graphic user interface 114, or the audio user interface 115.

In addition to storing the consumer profile information described previously, the local consumer profile 118 may comprise consumer-specified criteria regarding which advertisements 126 the operator of the consumer computer 102 wishes to be displayed. If the targeted ad 124 does not contain information that falls within the consumer-specified criteria, that targeted ad 124 is precluded from being displayed by the consumer computer 102. For example, the consumer-specified criteria may comprise an adjustable consumer ask price. The consumer ask price may be set by the consumer as a minimum price that advertisers pay to the consumer for his/her attention to an advertisement 126. The consumer ask price may be an amount of money, or some other reward such as coupons, points that may be used to make purchases, airline miles, or free gifts. The consumer ask price allows the consumer to control the value of his/her attention to an advertisement 126 and discourages advertisers from sending unsolicited advertisements by requiring the advertiser to pay each consumer for his/her attention to an advertisement at a price controllable by the consumer. In embodiments in which the local consumer profile 118 comprises both consumer profile information and a consumer ask price, the target profile 128 of each targeted ad 124 may comprise target criteria and a bid price.

In at least some embodiments, some of the computer-readable instructions 142 may be executed by the CPU 104 in the “background” of the consumer computer 102 (i.e., transparently to the operator without requiring action on the part of the operator). For example, the log consumer activity instructions 144 may be executed to transparently track the computer-based activities described previously and the generate consumer profile instructions 146 may transparently generate/update the local consumer profile 118.

When executed by the CPU 104, the compare targeted ad instructions 148 may cause the CPU 104 to compare a targeted ad 124 with the local consumer profile 118. As shown in FIG. 2A, the targeted ad 124 may be associated with a targeted advertising service 122 of the network 120. The network 120 also may comprise an email server 132 that provides emails 132 to the consumer computer 102. The consumer computer 102 may receive the targeted ad 124, the emails 132, and other electronic content (e.g., web pages, search engine results, multimedia) via the network interface 108. In at least some embodiments, an operator of the consumer computer 102 may specify the interaction (i.e., the exchange of data) between the consumer computer 102 and the network 120 by inputting information (e.g., Internet domain names and consumer information) via the input device 112.

When executing the compare targeted ad instructions 148, consumer privacy may be protected in several ways. For example, the local consumer profile 118 may be stored in a local memory (e.g., the local memory 106) of the consumer computer 102 and not on the network 120 so that access to the local consumer profile 118 is limited. Additionally, encryption, passwords or other techniques may be implemented to protect the security of the information stored in the local consumer profile 118.

When executed by the CPU 104, the profile editor instructions 150 enables an operator of the computer 102 to make changes to the local consumer profile 118. For example, it may be desirable that an operator of the consumer computer 102 delete, add, or edit information associated with the local consumer profile 118. Therefore, the profile editor instructions 150 may provide an interface (e.g., a window on the graphic user interface 114) that permits the operator to view information stored in the local consumer profile 118 and make changes to the stored information. Accordingly, the local consumer profile 118 may contain only information that the consumer wants to make available for comparison with the targeted ad 124. In some embodiments, deleting, adding, and editing the local consumer profile 118 may be limited or disabled to preserve the validity of some or all of the information in the local consumer profile 118. In embodiments where the profile 118 is not editable, code encryption or obfuscation (i.e., intentionally making the source code hard to understand) may be used to prevent software hackers from accessing and/or editing the profile 118. Additionally, some computers 102 may implement special hardware that would prevent the profile 118 from being manipulated (e.g., the Trusted Computing Platform (TCP)).

When executed by the CPU 104, the email interface instructions 152 may function to generate an email 132 which contains the advertisement 126, a hyperlink to the advertisement 126, or information that directs the consumer to the advertisement 126. The email 132 may be generated when the local consumer profile 118 matches a threshold amount of criteria of the target profile 128. If the email server 130 is included as part of the network 120, a data encryption technique may be implemented to protect the emails 132 and the email server 130 from unauthorized access.

Although the email server 130 is shown as part of the network 120 in FIG. 2A, the email server 130 and the emails 132 may alternatively be stored and accessed as part of the consumer computer 102. FIG. 2B shows a computer system 101 in accordance with alternative embodiments of the invention. As shown in FIG. 2B, the system 101 may be equivalent to the system 100 (shown in FIG. 2A) except the email server 130 and the emails 132 are stored and accessed in the local memory 106. The embodiment of FIG. 2B may provide improved security and/or may simplify security measures that are needed when the email server 130 and the emails 132 are stored and accessed on a network.

In both FIGS. 2A and 2B, the emails 132 may be viewed by an operator of the consumer computer 102 by executing the email browser application 117. The email browser application 117 may cause the CPU 104 to display the emails 132 on the graphic user interface 114. Also, the email browser application 117 may include various functions that allow the operator to reply to the emails 132, organize the emails 132, create emails 132, or other functions. The email browser application 117 may present emails 132 associated with an advertisement 126 of the targeted ad 124 together with other emails 132 that are not associated with the advertisement 126. Alternatively, the email interface instructions 152 may cause the email browser application 117 to separate emails 132 that are associated with the advertisement 126 from emails 132 that are not associated with the advertisement 126. The emails 132 that are associated with the advertisement 126 may then be more easily recognized, accessed, or ignored.

In at least some embodiments, advertisers may not be informed when the targeted ad 124 matches a local consumer profile 118, but may be informed when a consumer chooses to view the advertisement 126. For example, when a consumer chooses to open an email 132 associated with the advertisement 126, information from the profile 118 may be released to the advertiser associated with the advertisement 126.

Additionally, the email interface instructions 152 also may cause the email browser application 117 to display information associated with the targeted advertising service 122. For example, the interface instructions 152 may cause the email browser 117 to display a user-selectable item such as an icon, a scroll down menu or some other user-selectable item. When a consumer selects the user-selectable item (e.g., by clicking or double-clicking on the user-selectable item with the input device 112), the interface instructions 152 may cause a window to appear whereby the consumer may view earned incentives, sponsors, available rewards, advertisement types (e.g., video, web page, text), expiration dates of current offers, and target profile information.

As previously mentioned, embodiments of the invention may use other communication mediums and communication platforms (besides email 132 and the email browser application 117). For example, voice messages provided by a voice over IP application, messages provided by an instant messaging application, information printed directly on a consumer's printer, or direct mail generated and sent to a consumer may be used to present advertisements to consumers. In general, embodiments of the invention implement computer readable instructions 142 that, when executed, cause a consumer computer 102 to log computer activities, generate a local consumer profile that comprises a first set of information, interpret a targeted advertisement containing a second set of information, compare the first set of information to the second set of information, and, if a threshold amount of the second set of information matches with the first set of information, interface an advertisement with a communication medium of a communication platform executed by the consumer computer 102.

As an example, suppose an advertiser is in search of a consumer who has at least twice (e.g., separated in time by at least 5 hours) spent time on three web sites (X, Y, Z) related to automobiles, and has viewed web pages describing SUVs made by automobile companies A and B. The advertiser may further require that the consumer has done an Internet search during the last three weeks containing the terms “SUV” and “safety,” but who has never visited the website of automobile company C, who also makes SUVs. The advertiser (e.g., automobile company C) may be willing to pay, for example, $3 to a consumer for his/her attention, if the above criteria are met. Therefore, the advertiser would generate a targeted ad 124 in which the target profile 128 contains the website visits, the web searches, and time requirements specified above. The target profile 128 may also include a bid price of $3. At the consumer computer 102, the targeted ad 124 is received, and the target profile 128 is compared to the local consumer profile 118 by executing the compare targeted ad instructions 148. If the criteria specified in the target profile 128 is found within the local consumer profile 118, an email 132 associated with the advertisement 126 may be generated by the email interface instructions 116. The consumer may then access the advertisement 126 by executing the email browser application 117 and opening the email 132. As previously explained, the target profile 128 may include a bid price and the local consumer profile 118 may include a consumer ask price. In the above example, the consumer ask price would need to be $3 dollars or less for the ad to be displayed (assuming the advertiser submitted a bid price of $3).

In some embodiments, the advertisement 126 of a targeted ad 124 may be customized to the consumer. As an example, an advertisement 126 based on the criteria given above may include the statement, “Reasons why SUV of automobile company C is superior to the SUVs of automobile companies A and B.” Given the consumer's recent behavior and the cash incentive, the consumer may be willing to spend time to view the advertisement. The consumer also may be a discriminating consumer who dislikes unsolicited advertisements, and may accordingly set his/her consumer ask price at a relatively high value, for example, $2. Therefore, only a targeted ad 124 that includes a bid price incentive of at least $2 would be interfaced with an email 132 by the email interface instructions 152 (regardless of whether the other criteria included in the target profile 128 matches with the local consumer profile 118).

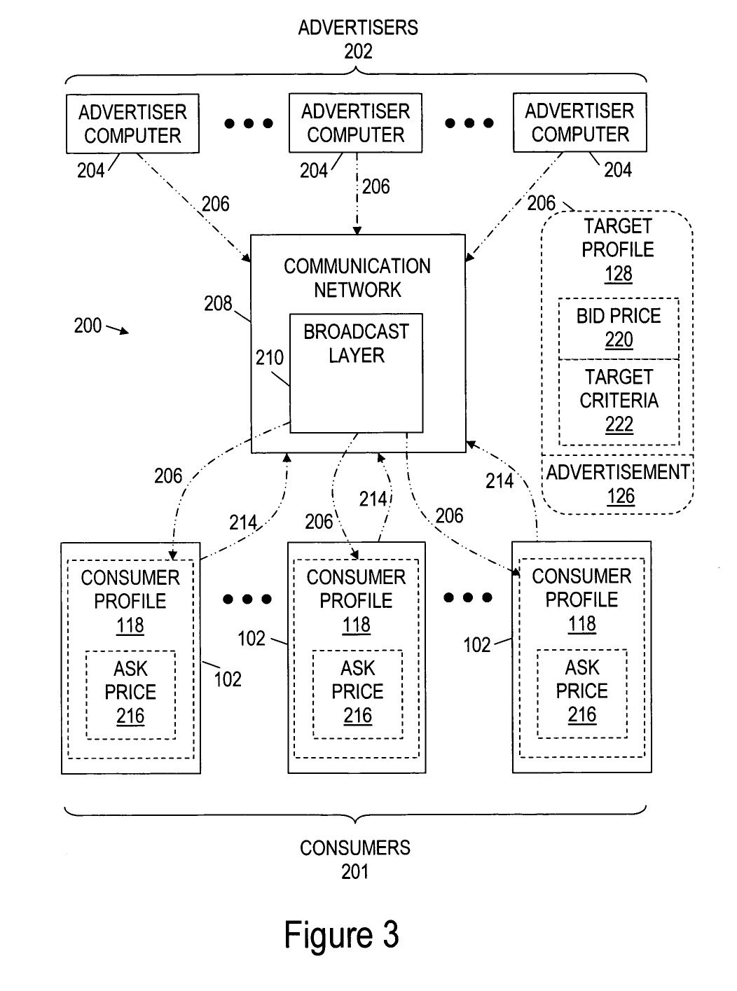

FIG. 3 shows a block diagram illustrating a system 200 according to another embodiment of the invention. As shown in FIG. 3, the system 200 may comprise a plurality of advertiser computers 204 and consumer computers 102 coupled to each other through a communication network 208 having a broadcast layer 210. The advertisers 202 may use the computers 204 to send advertisement messages 206 to the communication network 208. Each advertisement message 206 may comprise a target profile 128 and an advertisement 126. As previously explained, the target profile 128 may comprise a bid price 220 and a set of target criteria 222. In at least some embodiments, the communication network 208 may be a server that broadcasts advertisement messages 206 to the consumer computers 102. As shown in FIG. 3, each consumer computer 102 may contain a consumer profile 118 and an ask price 216. In at least some embodiments, the network 200 may be combined with existing spam blocking tools, whereby unknown advertisers would pay the consumers 201 for their attention to advertisements 126.

The broadcast layer 210 may be one of, or a combination of several possibilities that include, but are not limited to, a direct server to PC (personal computer) connection over the Internet, an indirect connection through a peer-to-peer scheme (i.e., each party may control initiation of a communication session), or a datacasting method (i.e., satellite communications) that broadcasts a digitized advertisement message 206 over a television infrastructure. The communication network 208 may send the advertisement messages 206 to all or some of the consumer computers 102 using the broadcast layer 210.

As previously explained, the consumers 201 may control participation in the advertisement network 200. For example, a consumer 201 may disable the consumer profile 118 on his/her computer 102. Additionally or alternatively, the consumer profile 118, including the ask price 216, may be editable for each consumer 201. A consumer 201 also has the option of simply not responding to an advertisement message 206 that matches his/her consumer profile 118. If a required portion of the target profile 128 of an advertisement message 206 matches a consumer profile 118 as previously described, a consumer 201 may choose not to open the email or other communication medium that is associated with the advertisement 126.

If an advertisement message 206 matches a consumer's profile 118, that consumer 201 may choose to view the advertisement 126 and receive an incentive associated with viewing the advertisement 126. In at least some embodiments, a consumer may send a response 214 to the communication network 208. The response 214 may be an acknowledgement that indicates to an advertiser 202 that the advertisement 126 of an advertisement message 206 has been viewed. In some embodiments, the response 214 may be an email response, hyperlink access, or an exchange of information (e.g., personal information).

There are at least two ways to control the amount of incentives that a consumer receives for viewing an advertisement. In general, a function V(A, B) that describes the relationship between consumer ask price (“A”) and bid price (“B”) may be programmed in the advertisement message 206 or the instructions 142 (shown in FIG. 1). For example, if A=$3 and B=$5, V(A, B) determines whether the consumer receives $3 or $5 or something in between. If V(A, B)=A, then a consumer only receives the consumer ask price A for viewing an advertisement, even if B is more valuable than A. However, if V(A, B)=B, the consumer receives the bid price B for viewing an advertisement. Using a V(A, B)=A relationship may encourage a consumer to set his/her ask price A high enough to make viewing advertisements worthwhile. For example, a consumer who sets the consumer ask price A at $0, will not receive any incentive for viewing ads attached to an advertisement message 204 if the V(A, B)=A relationship is used.

Alternatively, a function T(V(A, B)) may programmed into the advertisement messages 206 or the instructions 142 (shown in FIG. 2A). The function T(V(A, B)) may be the same as V(A, B) explained above except that a portion of any incentive offered by an advertiser to a consumer is given to the owner of the communication network 208. For example, the network owner may receive 25% of the incentive given to the consumer.

In is noted that minimizing and mitigating threats to the integrity of the advertising network 200 may be considered. For example, a consumer 201 may be tempted to scam the network 200 in order to receive as many advertiser incentives as possible. Accordingly, the network 200 may implement a variety of defenses to prevent or minimize the occurrence of scams. For example, the network 200 may cap the amount of incentives that a consumer is able to receive per time period (e.g., hour, day, week, or month). In some embodiments, the target profile 128 of the advertisement message 206 may require that consumers 201 actually have made purchases of a product and/or require a highly specific set of target consumer activities. Furthermore, consumers 201 may be required to view the advertisement and input certain information (to verify that they saw the offer) before they can receive the incentive offered. Further still, methods of accessing advertisements that prevent computer automated accesses may be implemented (e.g., Turing tests).

Another solution may involve each consumer computer 102 having two versions of a consumer profile 118. For example, one version may be plaintext, and the other may be a hashed (i.e., encrypted) version of the profile. In one embodiment, the hashed version may be a one-way global function accessible by the network 208. The target profiles 128 could be sent in hashed form also, and compared against the hashed version of a consumer profile 118. Only if a match occurs can the plaintext of the target profile 128 be determined (e.g., a hashed value in a location of hashed profile may correspond to a plaintext value in the plaintext version at the same relative location). If no match of hashed values occurs, then the plaintext value cannot be determined (because there is no matching entry in the hashed profile database). This solution would inhibit hackers and malicious users, by requiring they actually perform the activities required by a target profile 128 before viewing an advertisement 126 and receiving any incentive.

Advertisers 202 also may threaten the integrity of the network 200. For example, an advertiser 202 may try to discover information and identities of the consumers 201. Accordingly, the communications network 208 should ensure that the advertisement messages 206 contain no web bugs that comprise, for example, programs written to allow an advertiser 202 to match an Internet Protocol (IP) address with the fact that a target profile 128 matched a consumer profile 118 associated with that address. Preventing web bugs as described above may be accomplished by examining the advertisement messages 206 before they are broadcast and destroying any advertisement messages 206 that include web bugs or other detrimental programs.

Other considerations relevant to the advertising network 200 may include limiting the cost of advertising using the network 200. For example, some advertisers 202 may not want to pay an unknown quantity of incentives to consumers. Limiting advertiser expense may be accomplished by one or more methods including, but not limited to, capping the number of matching customers 201 that will receive an incentive, sampling a small percentage of the overall population of an area and estimating the result of an advertisement 126 from the sampling, using a peer-to-peer architecture to estimate the number of matching consumers 201, and implementing Internet voting protocols.

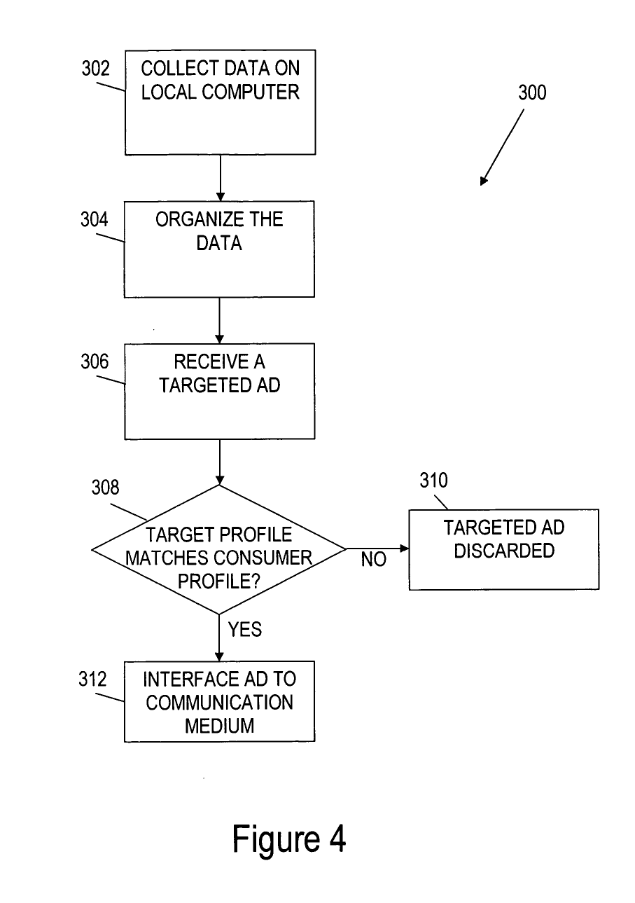

FIG. 4 shows a method 300 for advertising according to an embodiment of the invention. As shown in FIG. 4, the method comprises collecting consumer data on a local computer (block 302), and organizing the consumer data (block 304). As previously explained with regard to FIG. 2A, a consumer profile may be generated and used to organize the consumer data. The method 300 further comprises receiving a targeted ad (block 306). As described in FIG. 3, a targeted ad (advertisement message) may comprise a target profile, and an advertisement. If the target profile matches a consumer profile as determined by block 308, an advertisement is made available by interfacing the advertisement with a communication medium of a communication application (block 312). Some examples of possible communication mediums and respective communication applications include emails of an email browser, instant messages of an instant messenger, and messages of a voice over IP application. If the target profile does not match the consumer profile as determined by block 308, the targeted ad is discarded (block 310). As previously explained, a target profile may match a consumer profile when a set of target criteria included with the target profile is found in the consumer profile. Additionally, or alternatively, a bid price that is greater than or equal to a consumer ask price may determine when a target profile matches a consumer profile.

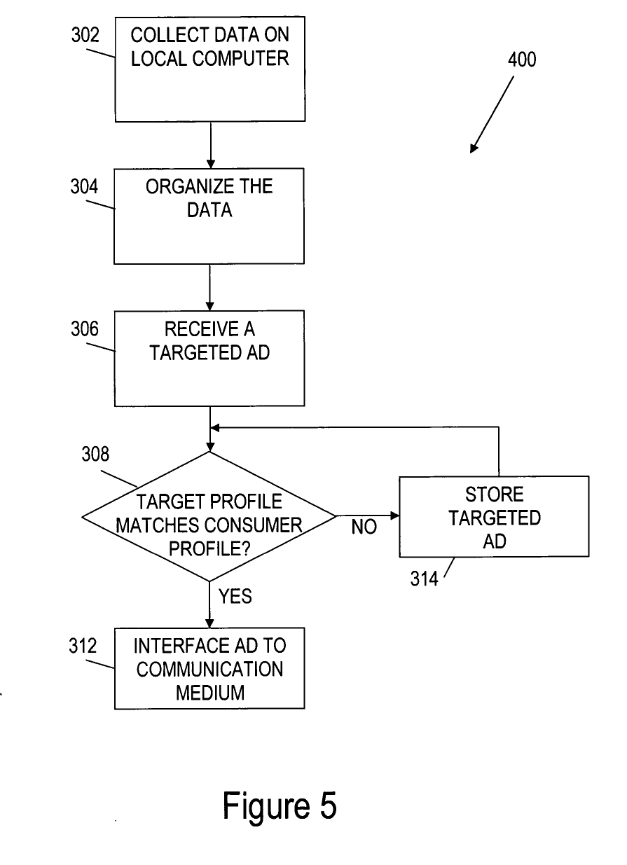

FIG. 5 shows a method 400 of advertising according to another embodiment of the invention. As shown, the method 400 is generally identical to the method 300 described above. However, the method 400 does not discard targeted ads (block 310, FIG. 4) when they do not match the consumer profile (block 308, FIG. 4) as described for method 300. Instead, the targeted ads may be stored (block 314) and periodically compared to the consumer profile at a later time. The method 400 permits several functions including, but not limited to, displaying targeted ads according to later consumer activities, e.g., web searches or web sites visited, without requiring multiple broadcasts of the targeted ad. Using this method 400, a targeted ad may be broadcast only once, but will effectively appear (via the communication medium of a communication platform) at a time when a consumer has met the target consumer criteria.

The above discussion is meant to be illustrative of the principles and various embodiments of the present invention. Numerous variations and modifications will become apparent to those skilled in the art once the above disclosure is fully appreciated. It is intended that the following claims be interpreted to embrace all such variations and modifications.

1. A system, comprising:
a targeted advertisement service unit configured to broadcast a signal having target criteria and advertisement information; and a user device that stores and executes a targeted advertisement client configured to interpret the signal and compare the signal with user information logged by the targeted advertisement client; wherein the user device further stores and executes a message generator configured to generate a message interfaced with the advertisement information if the target criteria matches a threshold amount of the user information;
wherein the user device further stores and executes a message presentation client configured to receive and present both the message interfaced with the advertisement information and other messages.

2. The system of claim 1 further comprising a message server that receives and stores the message interfaced with the advertisement information and other messages for access by the message presentation client.

3. The system of claim 2 wherein the message server is local to the user device such that transmission of messages to and from the message server does not involve a network server.

4. The system of claim 2 wherein the message server is coupled to the user device via a network server such that transmission of the messages to and from the message server involves the network server.

5. The system of claim 1 wherein the signal and the message interfaced with the advertisement information are formatted differently such that the message presentation client is unable to directly interpret the signal.

6. The system of claim 1 wherein the message is an email and the message presentation client is an email browser.

7. The system of claim 1 wherein the message and the message presentation client are selected from the group of messages and message presentation clients consisting of:
emails and an email browser;
instant messages and an instant messaging application;
voice messages and voice over IP application; and
printable messages and a printer client.

8. The system of claim 1 wherein the target criteria comprises a bid price and the user information comprises a bid price

9. The system of claim 1 wherein the targeted advertisement client implements an encryption technique to compare the target criteria to the user information.

10. A computer, comprising:
a CPU;
a network interface coupled to the CPU, wherein the network interface is configured to receive a signal having a target profile and advertisement data from a network; and a local memory coupled to the CPU; wherein the local memory stores a targeted advertisement client, that when executed by the CPU, compares the target profile of a received signal with a logged consumer profile; wherein the memory further stores a email generator that, when executed by the CPU, generates an email interfaced with the advertisement data of the received signal if the target profile matches the consumer profile.

11. The computer of claim 10 wherein the email is transmitted to an email server for storage therein and accessible to a user when the CPU executes an email browser.

12. The computer of claim 11 wherein the email server is a local component of the computer.

13. The computer of claim 11 wherein the email server is accessed via an Internet connection.

14. The computer of claim 10 wherein the targeted advertisement client, when executed by the CPU, causes the consumer profile to be generated and stored locally as a searchable database.

15. The computer of claim 10 wherein the targeted advertisement client, when executed by the CPU, allows an operator to edit the consumer profile via an input device coupled to the computer.

16. The system of claim 10 wherein the target profile matches the consumer profile if a threshold set of criteria of the target profile is found within the consumer profile.

17. The system of claim 10 wherein the target profile matches the consumer profile if a bid price is greater than or equal to a consumer ask price.

18. The system of claim 17 wherein at least one of the targeted advertisement client and the target profile implements an algorithm that determines an incentive, offered to a consumer, that is based on the bid price and the consumer ask price.

19. The system of claim 18 wherein the incentive is equal to the bid price when the bid price is greater than the consumer ask price.

20. The system of claim 18 wherein the incentive is equal to the consumer ask price when the bid price is greater than the consumer ask price.

21. A system, comprising:
a first computer;
a communication network coupled to the first computer, the communication network receives a first message, having a target profile and an advertisement, from the first computer and broadcasts the first message; and
a second computer that receives the first message from the communication network, compares the target profile of the first message with the consumer profile and, if a required portion of the target profile matches the consumer profile, generates a second message interfaced with the advertisement of the first message, wherein the second message is transmitted to a message server for storage and access by a message presentation client stored locally on the second computer.

22. The system of claim 21 wherein said consumer profile comprises a log of activities performed by the second computer.

23. The system of claim 22 wherein said log of activities is associated with transactions an operator of the second computer performs over the communications network.

24. The system of claim 21 wherein the second message comprises email and wherein the message presentation client comprises an email browser.

25. The system of claim 21 wherein the first message is not directly interpretable by the message presentation client.

26. A method, comprising:
collecting data on a consumer computer;
receiving a signal having advertisement information and target criteria;
comparing said target criteria with the data; and
if the target criteria matches with the data, interfacing the advertisement information in a message format compatible with a message presentation client executed by the consumer computer.

27. The method of claim 26, wherein said collecting, receiving, comparing, and interfacing are performed locally on the consumer computer.

28. The method of claim 26 wherein said collected data comprises information that identifies computer-based activities of a consumer.

29. The method of claims 26 further comprising;
storing the advertisement information and the target criteria locally in the consumer computer if the target criteria does not match predetermined elements of the data; and
periodically comparing said target criteria with the data.

30. The method of claim 29 wherein the predetermined elements comprises a consumer ask price.

31. A storage medium containing computer-readable instructions that are executable by a computer and cause the computer to:
log computer activities;
create local consumer profile that comprises a first set of information;
interpret a targeted advertisement containing a second set of information;
compare the first set of information to the second set of information; and
if a threshold amount of the first and second sets of information match, interface the advertisement with a message that is interpretable by a message presentation client executed by the computer.

32. The storage medium of claim 31 wherein said local consumer profile further comprises a consumer ask price.

33. The storage medium of claim 31 wherein said first and second sets of information comprises information associated with computer-based activities of a consumer.

34. The storage medium of claim 31 wherein said computer-readable instructions further cause the computer to edit the local consumer profile according to input from an operator of the computer.

35. A system, comprising:
means for receiving a targeted advertisement;
means for comparing information embedded in the targeted advertisement with user controlled criteria pertaining to which ads are to be shown on the system; and
means for interfacing the advertisement with a message presentable by a message presentation application if the targeted advertisement falls within the user specified criteria.

36. The system of claim 35 further comprising means for precluding the advertisement from being shown if the information does not fall within the user specified criteria.

37. The system of claim 35 wherein said user specified criteria comprises a price paid to a user of the system for viewing the targeted advertisement.

38. A user device comprising:
a user profile;
user-specified criteria;
a target information client for receiving targeted information, target user profile, and sender-specified criteria;
a presentation client for presenting said targeted information via a presentation medium; and
a communication interface for facilitating transfer of said targeted information between said target information client and said presentation client, wherein said target information client compares said user profile and said user-specified criteria with said target user profile and said sender-specified criteria, and wherein if result of said comparison satisfies threshold criteria, said target information client transfers said targeted information to said communication interface for transferring to said presentation client.

39. The user device as recited in claim 38 wherein said targeted information comprises advertisement.

40. The user device as recited in claim 38 wherein said presentation client comprises an email client.

41. The user device as recited in claim 38 wherein said user device is one of a computer, a mobile phone, and a personal digital assistant.

42. The user device as recited in claim 38 wherein said presentation medium is one of an email application, an instant messaging application, a Voice over IP application, and a printer application.

43. A method of delivering targeted information to a user device, said method comprising:
sending said targeted information, target user profile, and sender-specified criteria;
receiving said targeted information, target user profile, and sender-specified criteria at said user device;
comparing a user profile and user-specified criteria with said target user profile and said sender-specified criteria; and
if result of said comparison satisfies threshold criteria, transferring said targeted information client to a communication interface for transferring to a presentation client for presenting said targeted information via a presentation medium.

44. The method as recited in claim 43 wherein said targeted information comprises advertisement.

45. The method as recited in claim 43 wherein said presentation client comprises an email client.

46. The method as recited in claim 43 wherein said user device is one of a computer, a mobile phone, and a personal digital assistant.

47. The method as recited in claim 43 wherein said presentation medium is one of an email application, an instant messaging application, a Voice over IP application, and a printer application.

48. An information transmitter comprising:
targeted information, a target user profile, and sender-specified broadcast service limitations provided by one or more senders; and
a broadcasting service device coupled to a network and for broadcasting said targeted information and said target user profile to a plurality of user devices coupled to said network, and wherein said broadcasting service device is configured to determine whether any user profile of each user device satisfied said target user profile.

49. The information transmitter as recited in claim 48 wherein said targeted information comprises advertisement.

50. The information transmitter as recited in claim 48 wherein said network is a wired network.

51. The information transmitter as recited in claim 48 wherein said network is a wireless network.

52. The information transmitter as recited in claim 48 wherein each user device is one of a computer, a mobile phone, and a personal digital assistant.

53. A method of transmitting to a plurality of user devices, said method comprising:
receiving targeted information, a target user profile, and sender-specified broadcast service limitations from one or more senders;
broadcasting via a network said targeted information and said target user profile to said user devices coupled to said network;
determining whether any user profile of each user device satisfied said target user profile; and
adjusting said broadcasting based on said sender-specified broadcast service limitations.

54. The method as recited in claim 53 wherein said targeted information comprises advertisement.

55. The method as recited in claim 53 wherein said network is a wired network.

56. The method as recited in claim 53 wherein said network is a wireless network.

57. The method as recited in claim 53 wherein each user device is one of a computer, a mobile phone, and a personal digital assistant.

58. An information sender comprising:
storage device for targeted information, a target user profile, and information sender-specified broadcast service limitations; and
a transmission device to transmit said targeted information, said target user profile, and said information sender-specified broadcast service limitations to a broadcasting service for broadcasting to a plurality of user devices coupled to a network.

59. The information sender as recited in claim 58 wherein said targeted information comprises advertisement.

60. The information sender as recited in claim 58 wherein said network is a wired network.

61. The information sender as recited in claim 58 wherein said network is a wireless network.

62. The information sender as recited in claim 58 wherein each user device is one of a computer, a mobile phone, and a personal digital assistant.

63. A method of distributing targeted information to a plurality of user devices, said method sender comprising:
creating said targeted information, a target user profile, and information sender-specified broadcast service limitations; and
transmitting said targeted information, said target user profile, and said information sender-specified broadcast service limitations to a broadcasting service for broadcasting to a plurality of user devices coupled to a network.

64. The method as recited in claim 63 wherein said targeted information comprises advertisement.

65. The method as recited in claim 63 wherein said network is a wired network.

66. The method as recited in claim 63 wherein said network is a wireless network.

67. The method as recited in claim 63 wherein each user device is one of a computer, a mobile phone, and a personal digital assistant.

68. Application instructions on a computer-usable medium where the instructions, when executed, effect delivering targeted information to a user device, comprising:
sending said targeted information, target user profile, and sender-specified criteria;
receiving said targeted information, target user profile, and sender-specified criteria at said user device;
comparing a user profile and user-specified criteria with said target user profile and said sender-specified criteria; and
if result of said comparison satisfies threshold criteria, transferring said targeted information client to a communication interface for transferring to a presentation client for presenting said targeted information via a presentation medium.

69. The application instructions on a computer-usable medium as recited in claim 68 wherein said targeted information comprises advertisement.

70. The application instructions on a computer-usable medium as recited in claim 68 wherein said presentation client comprises an email client.

71. The application instructions on a computer-usable medium as recited in claim 68 wherein said user device is one of a computer, a mobile phone, and a personal digital assistant.

72. The application instructions on a computer-usable medium as recited in claim 68 wherein said presentation medium is one of an email application, an instant messaging application, a Voice over IP application, and a printer application.

73. Application instructions on a computer-usable medium where the instructions, when executed, effect transmitting to a plurality of user devices, comprising:
receiving targeted information, a target user profile, and sender-specified broadcast service limitations from one or more senders;
broadcasting via a network said targeted information and said target user profile to said user devices coupled to said network;
determining whether any user profile of each user device satisfied said target user profile; and
adjusting said broadcasting based on said sender-specified broadcast service limitations.

74. The application instructions on a computer-usable medium as recited in claim 73 wherein said targeted information comprises advertisement.

75. The application instructions on a computer-usable medium as recited in claim 73 wherein said network is a wired network.

76. The application instructions on a computer-usable medium as recited in claim 73 wherein said network is a wireless network.

77. The application instructions on a computer-usable medium as recited in claim 73 wherein each user device is one of a computer, a mobile phone, and a personal digital assistant.

78. A system for delivering targeted information to a user device, said system comprising:
means for sending said targeted information, target user profile, and sender-specified criteria;
means for receiving said targeted information, target user profile, and sender-specified criteria at said user device;
means for comparing a user profile and user-specified criteria with said target user profile and said sender-specified criteria; and
if result of said comparison satisfies threshold criteria, means for transferring said targeted information client to a communication interface for transferring to a presentation client for presenting said targeted information via a presentation medium.

79. The system as recited in claim 78 wherein said targeted information comprises advertisement.

80. The system as recited in claim 78 wherein said presentation client comprises an email client.

81. The system as recited in claim 78 wherein said user device is one of a computer, a mobile phone, and a personal digital assistant.

82. The system as recited in claim 78 wherein said presentation medium is one of an email application, an instant messaging application, a Voice over IP application, and a printer application.
